(19) United States
(12) Patent Application Publication
(10) Pub. No.: US 2021/0059316 A1
(43) Pub. Date: Mar. 4, 2021

(54) Case for Electronic Cigarette and Associated Filter

(71) Applicant: SLEAV LLC, San Diego, CA (US)

(72) Inventor: Gary Pietryk, San Diego, CA (US)

(21) Appl. No.: 16/559,461

(22) Filed: Sep. 3, 2019

(51) Int. Cl. A24F 47/00; A24F 13/00; B01D 46/00

(52) U.S. Cl. CPC A24F 47/008; B01D 2265/02; B01D 46/0005; A24F 13/00

(57) ABSTRACT

Various embodiments of a case for holding an e-cigarette and a removable filter cartridge are disclosed. The removable filter cartridge may slide into a cavity that is formed within the case to house the filter. The cavity may be formed to conform to the outer dimensions of a portion of the filter, such that the filter slides into the case. A mouthpiece may be integral to the filter to mate with the case in a manner that provides an attractive and smooth exterior when the filter is mated within the case.

### BACKGROUND

### (1) Technical Field

The disclosed method and apparatus relate generally to a cigarette holder. In particular, the disclosed method and apparatus relates to a case in which an electronic cigarette and an associated filter can be placed when a user is smoking the electronic cigarette and for securing both the electronic cigarette and an associated filter when not in use.

### (2) Background

The use of electronic cigarettes is commonplace. Electronic cigarettes are a convenient way to smoke in many situations in which it is either inconvenient or inappropriate to smoke a conventional cigarette. Electronic cigarettes, or “e-cigarettes”, are battery operated devices that typically deliver nicotine contained within an inhaled vapor or, alternatively, non-nicotine solutions, for the user to inhale. Most e-cigarettes aim to provide a similar sensation to inhaling tobacco smoke, without the smoke and carcinogens. Some e-cigarettes have a mouthpiece, or cartridge; a heating element; a rechargeable battery; and electronic circuits.

As the user sucks on the mouthpiece, a sensor activates a heating element that vaporizes a flavored, liquid solution held in the mouthpiece. The person then inhales the aerosol solution.

In some such e-cigarettes, the mouthpiece is a cartridge that is fixed to the end of a tube. A small plastic cup within the mouthpiece holds an absorbent material drenched in the liquid solution. The cartridge can either be refilled or replaced with another pre-filled cartridge when necessary. The atomizer is a heating element that heats the liquid, causing it to vaporize. The solution can then be breathed in, or inhaled. The battery powers the heating element. This is normally a rechargeable, lithium-ion battery. The sensor activates the heater when the user sucks on the device. An LED may show when it is activated.

The solution, sometimes referred to as “e-liquid” is made by extracting nicotine from tobacco and mixing it with a base, usually propylene glycol, and flavoring. Propylene glycol is used in inhalers, for example, for asthma. There is a wide range of flavors to choose from, with names such as traditional, mango, menthol, and cotton candy. Some flavors, such as a combination of tobacco and menthol, try to resemble traditional cigarettes. A number of them claim to mimic specific brands.

Since entering the market in 2003, use of e-cigarettes become very popular. A 2014 survey indicated that around 10% of American adults were users. Interest has been global, with the UK seeing an increase from 700,000 users in 2012 to 2.6 million users in 2015. While many still use traditional cigarettes, many people that smoke conventional cigarettes are switching to e-cigarettes. Most peoples' reason for using e-cigarettes involve trying to quit smoking, though a large proportion use them recreationally. Large tobacco companies have greatly increased their marketing efforts, increasing the popularity of e-cigarettes. As of 2014, there were 466 brands of e-cigarettes, with global sales of around $7 billion. In 2018, more than 10 million people used e-cigarettes daily. Everyday use is common among e-cigarette users. Adults often vape to replace tobacco.

FIG. 1 is an illustration of one type of e-cigarette unit. The user sucks on the proximal end 102 of the unit 100 that holds the components of the e-cigarette. An electrical connector 104 is provided on the distal end 106 to allow the rechargeable battery (not shown) within the unit 100 to be recharged. When the user draws air through the proximal end 102 of the unit 100, a heating element (not shown) within the unit 100 heats a liquid that is maintained within the unit 100. The heat causes the liquid to vaporize and allow the vapor to be drawn into the user's mouth. The user then typically exhales the vapor into the air.

The vapor that is exhaled is typically conspicuous but can be disturbing to those people around the person that is “vaping” with an e-cigarette.

Accordingly, it would be advantageous to provide a convenient filter that can be used by a person vaping to reduce the effects of vapor released. In addition, it would be advantageous for the filter to be held in a convenient manner and to have a convenient place to store the filter when not in use.

### SUMMARY

Various embodiments of a method and apparatus for providing a case to hold both an e-cigarette unit and an associated removable filter cartridge are disclosed. In some embodiments, the removable filter cartridge slides into a cavity that is formed within the case to house the filter. The cavity is formed to conform to the outer dimensions of a portion of the filter, such that the filter slides into the case. A mouthpiece that is integral to the filter mates with the case in a manner that provides an attractive and smooth exterior when the filter is mated within the case.

In one embodiment, a pair of straps secure the e-cigarette unit to the top of the case, over the portion of the case within which the removable filter cartridge resides. The e-cigarette unit slides back and forth along a glide path through the straps to allow the e-cigarette unit to be extended beyond the case to allow easily placement of the user's mouth around the e-cigarette unit. When not in use, the e-cigarette unit can be withdrawn back onto the case to allow for convenient storage.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of one type of e-cigarette unit.

FIG. 2 is side plan view of a case in accordance with one embodiment of the disclosed apparatus.

FIG. 3 is an end plan view looking from the proximal end of the case.

FIG. 4 is a perspective view of a case with a filter cartridge placed into the filter chamber.

FIG. 5 is a perspective view of a filter cartridge.

FIG. 6 is a top plan view of the case with a filter cartridge placed into the filter chamber.

FIG. 7 is a perspective view of a case with a filter cartridge placed within the filter chamber and an e-cigarette, like the e-cigarette shown in FIG. 1, placed within the e-cigarette receiving area.

FIG. 8 is a perspective view of the case with the e-cigarette in the “store” position.

FIG. 9 is a bottom plan view of the case with a filter cartridge placed into the filter chamber.

FIG. 10 is a plan view of the distal end of the case.

FIG. 11 is a side plan view of an alternative embodiment of a case.

FIG. 12 is a bottom view of the case.

FIG. 13 is an end plan view of the case.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

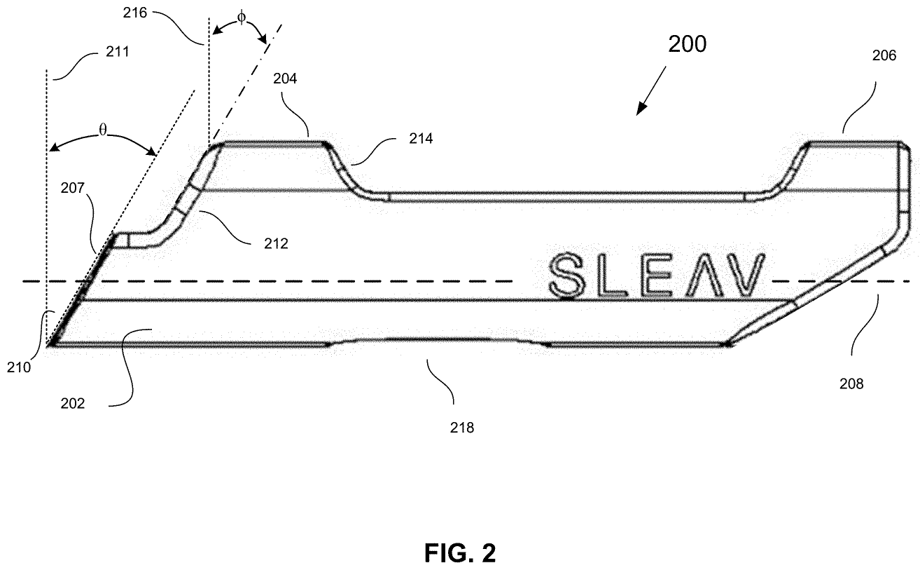

FIG. 2 is side plan view of a case 200 in accordance with one embodiment of the disclosed apparatus. The case comprises a body 202. The body 202 has a first strap 204 and a second strap 206. In some embodiments, the first strap 204 and the second strap 206 are aligned directly above and along a first case longitudinal axis 208 of the body 202. The straps 204, 206 each protrude upward from the body 202.

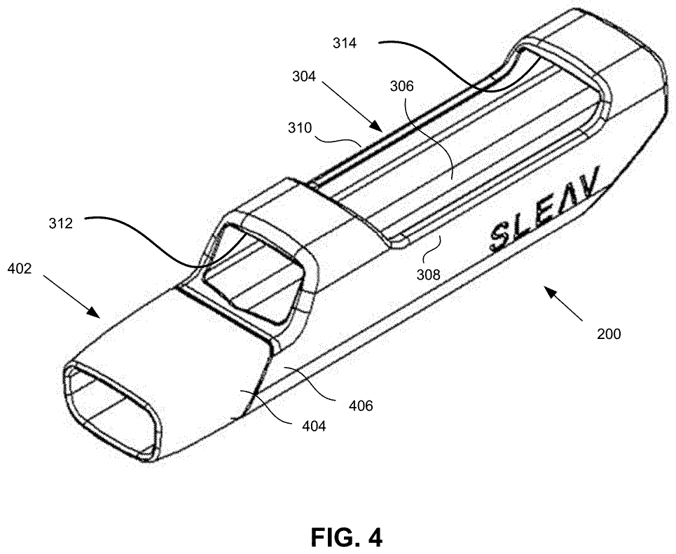

In some embodiments, a surface 207 at the proximal end 210 of the body 202 terminates the body 202 at an angle of θ with respect to a line 211 parallel to the vertical axis of the body 202. The angle θ provides an aesthetically pleasing interface between the mouthpiece of a removeable filter cartridge and the body 202, as will be discussed in greater detail below in the text associated with FIG. 4. The particular angle θ can be any pleasing angle between 0° and 50°, but can be outside that range for alternative embodiments. For example, the angle θ may be greater than 270° in some alternative embodiments. Similarly, the leading edge 212 of the first strap 204 is slanted at an angle ϕ with respect to a line 216 parallel to the vertical axis of the body 202. In some embodiments, the trailing edge of the strap 204 is slanted at an angle of 360°-ϕ. As is the case with the angle of surface 207, the angle ϕ is provided essentially for aesthetics and is not otherwise of great significance. Nonetheless, in some embodiments, the structural integrity of the straps may be enhanced by slanting the leading and/or trailing edges of the straps at a particular angle within a particular range of angles.

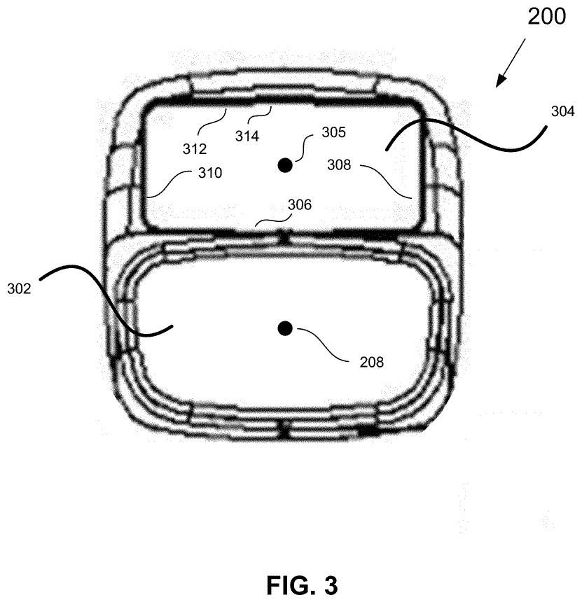

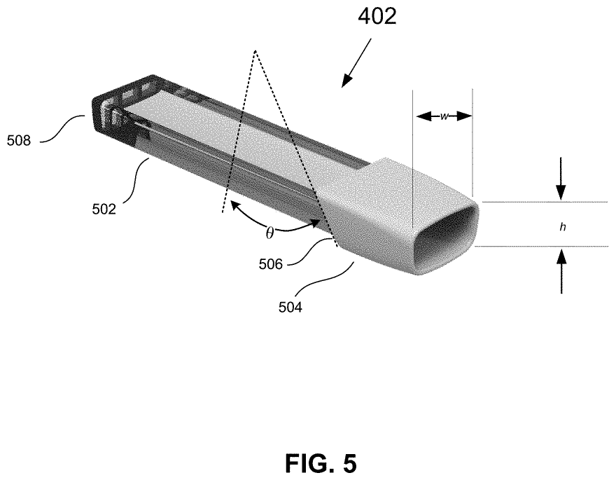

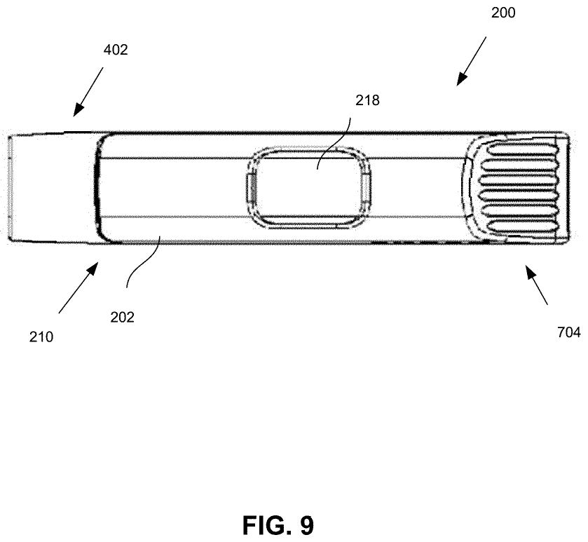

In some embodiments, a “window” 218 is provided on the bottom side of the body 202. In some embodiments, the window 218 provides a means by which the status of a filter held within a cavity in the body 202 can be determined (as will be discussed below with regard to the text associated with FIG. 3, FIG. 4 and FIG. 5 and best seen in FIG. 9).

FIG. 3 is an end plan view looking from the proximal end 210 of the case 200. An opening at the proximal end of a filter chamber 302 is shown in FIG. 3. The filter chamber 302 runs through the center of the body 202 running coincident to the first case longitudinal axis 208. The first case longitudinal axis 208 is best shown in FIG. 2 and is shown as a “dot” representing the axis being perpendicular to the plane of the figure. The filter chamber 302 is open on both the proximal end 210 and the distal end 213 of the body 202.

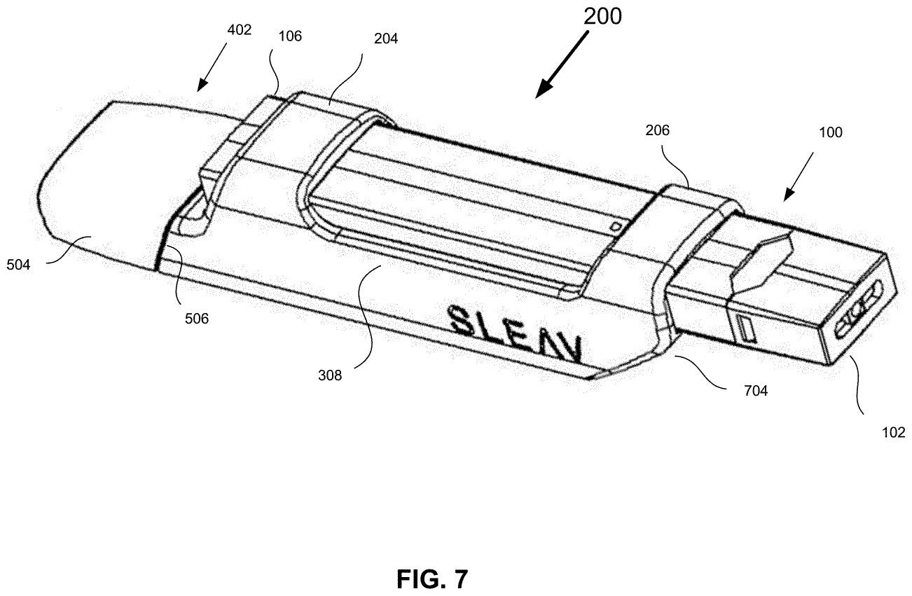

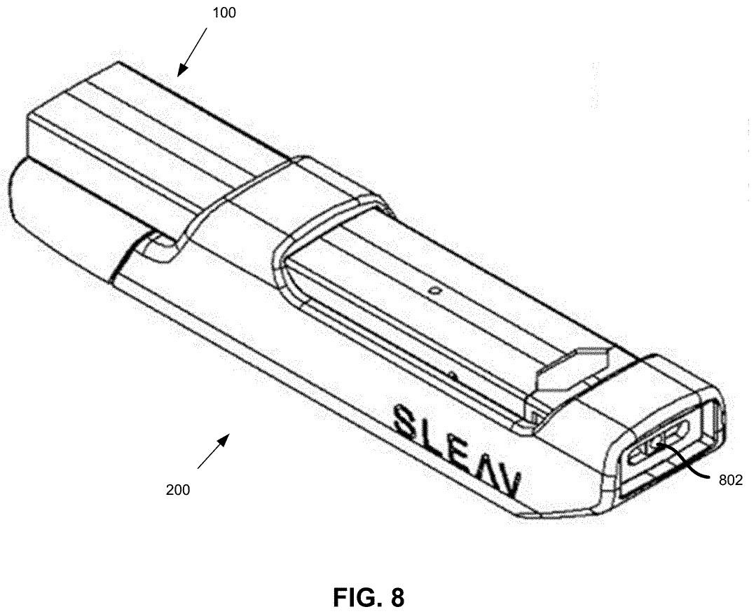

FIG. 4 is a perspective view of a case 200 with a filter cartridge 402 placed into the filter chamber 302. In addition to the filter chamber 302, an e-cigarette receiving area 304 is shown in FIG. 3 and FIG. 4. The receiving area 304 is defined by a receiving area floor 306, a receiving area right side wall 308, a receiving area left side wall 310 and a first receiving area partial ceiling 312 defined by the bottom of the first strap 204 and a second receiving area partial ceiling 314 defined by bottom of the second strap 206. The first and second receiving area partial ceiling 312, 314 cover only a portion of the receiving area 304. The receiving area 304 runs coincident to a second case longitudinal axis 305 (shown in FIG. 3 as a “dot” representing the axis being perpendicular to the plane of the figure). Additional aspects of the receiving area 304 are discussed below with regard to FIG. 7 and FIG. 8.

FIG. 5 is a perspective view of a filter cartridge 402. The filter cartridge 402 has a body 502 and a mouthpiece 504. In one embodiment of the disclosed apparatus, the body 502 is an elongated rectangle extending from the distal end 506 of the mouthpiece 504 to the distal end 508 of the filter cartridge 402. The filter cartridge 402 can be fabricated in various ways that would be known to those skilled in the art. The body 502 of the filter cartridge 402 slides into the filter chamber 302, being completely enclosed with the filter chamber 302. The mouthpiece 504 has a width, w and a height, h that are each slightly greater than the width and height of the body 502. In some such embodiments, the difference in the width and height of the mouthpiece 504 with respect to the body 502 of the filter cartridge 402 is equal to the twice the thickness of the walls of the case 200. Accordingly, the exterior surface 404 of the mouthpiece 402 is coplanar with the exterior surface 406 of the case 200 at each point at which the mouthpiece 402 and the case 200 come together when the filter cartridge 402 is fully engaged within the filter chamber 302 (i.e., has been slid all the way into the filter chamber 302). In addition, the angle θ of the distal end 506 of the mouthpiece 504 with respect to a vertical axis 510 is matched to the angle θ of the surface 207 at the proximal end 210 of the body 202 of the case 200. Accordingly, the distal end 506 of the mouthpiece 504 mates flush with the surface 207 at the proximal end 210 of the body 202, as best shown in FIG. 4.

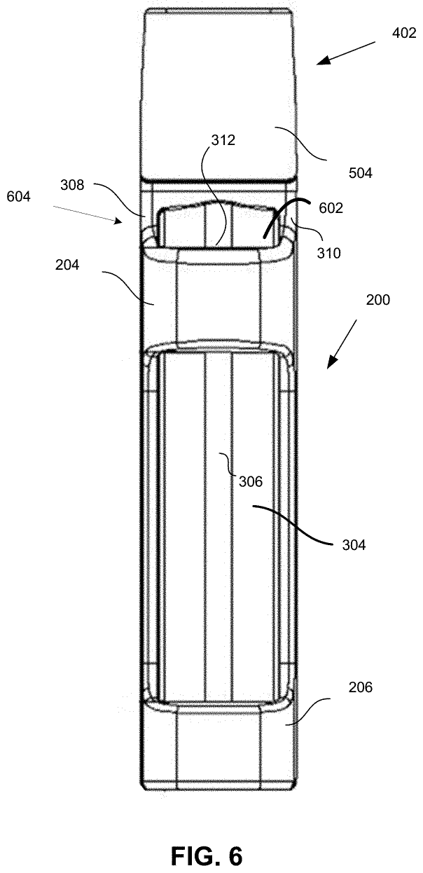

FIG. 6 is a top plan view of the case 200 with a filter cartridge 402 placed into the filter chamber 302 (not visible in FIG. 6). The mouthpiece 504 is shown protruding from the case 200. From this view, the first strap 204 and the second strap 206 can be seen extending over the e-cigarette receiving area 304. The opening 602 at the proximal end 604 of the e-cigarette receiving area 304, the receiving area 304 being defined by the floor 306, the right wall 308, the left wall 310 and the partial ceiling 312 (i.e., on the underside of the strap 204) best seen in FIG. 3.

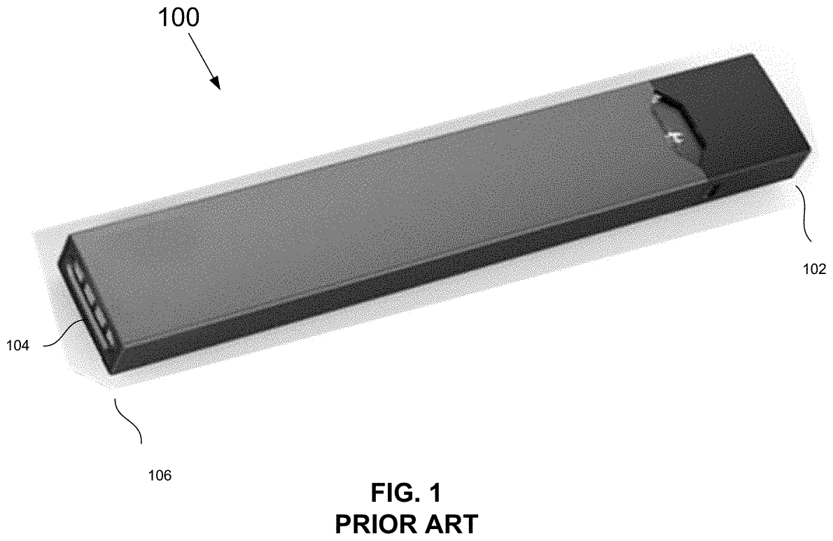

FIG. 7 is a perspective view of the case 200 with a filter cartridge 402 placed within the filter chamber 302 (not visible in FIG. 7) and an e-cigarette 100, like the e-cigarette 100 shown in FIG. 1, placed within the e-cigarette receiving area 304. The exterior dimensions of the e-cigarette 100 conform to the interior dimensions of the e-cigarette receiving area 304, allowing the e-cigarette 100 to be slid into the e-cigarette receiving area 304 (i.e., underneath the first and second straps 204, 206, between the right and left walls 308, 310 and over the floor 306 of the e-cigarette receiving area 304, best seen in FIG. 3, FIG. 4 and FIG. 6). When the e-cigarette 100 is in the position shown in FIG. 7 (“the vape position”), the proximal end 102 of the e-cigarette 100 extends beyond the distal end 704 case 200. The distal end 106 of the e-cigarette 100 is even with, or slightly beyond the distal end 506 of the mouthpiece 504 of the filter cartridge 402. In the vape position, the user can comfortably place his mouth around the proximal end 102 of the e-cigarette 100 to draw vapor from the e-cigarette 100 and then turn the case 200 around 180° to place his mouth around the mouthpiece 504 and exhale the vapor into the filter cartridge 402.

FIG. 8 is a perspective view of the case 200 with the e-cigarette 100 in the “store” position. The e-cigarette 100 is placed in the store position when the user is no longer actively using the e-cigarette (i.e., not engaged in “vaping”). Placing the e-cigarette 100 in the store position provides some protection against the e-cigarette being damaged. A charger (not shown) can be connected to the electronic connector 802 used to recharge the battery within the e-cigarette 100 in this position.

FIG. 9 is a bottom plan view of the case 200 with a filter cartridge 402 placed into the filter chamber 302 (not visible in FIG. 9). Looking from the bottom, a plurality of openings 902 into the filter chamber 302 can be seen at the distal end 704 of the case 200. Unlike the opening into the filter chamber 402 at the proximal end 210 of the body 202, the openings 902 are relatively small oval openings that allow the filtered air to exit from the filter cartridge 402 when the user exhales vapor through the mouthpiece 504 into the filter cartridge 402. The structure of the openings 902 provides structural support to assist the body 202 of the case 200 maintain its shape. In an alternative embodiment, a single opening, similar to the opening at the proximal end of the filter chamber 302, could be provided at the distal end of the filter chamber 302.

The window 218 can best be seen in FIG. 9. The window 218 provides a view into the filter chamber 302. With the filter placed inside the filter chamber 302, a user may be able to monitor the status of the filter cartridge 402 by viewing a portion of the body 502 of the filter cartridge 402 through the window 218.

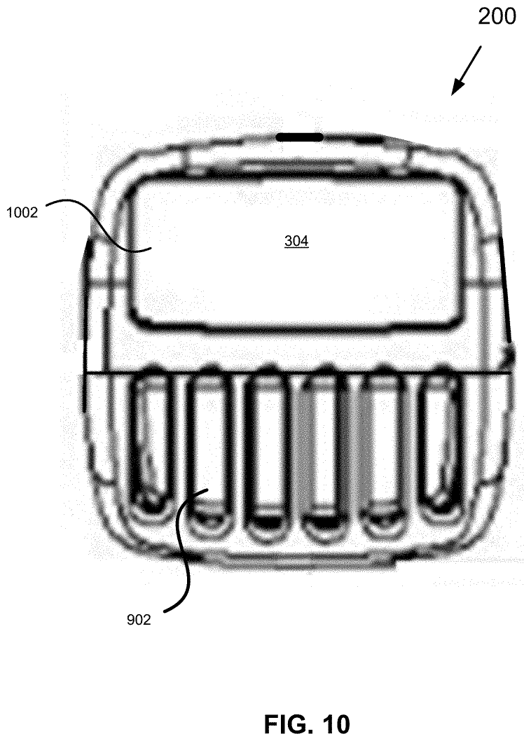

FIG. 10 is a plan view of the distal end 704 of the case 200. The openings 902 into the filter chamber 302 can be seen, as well as the opening 1002 into the e-cigarette receiving area 304 at the distal end 704 of the case 200.

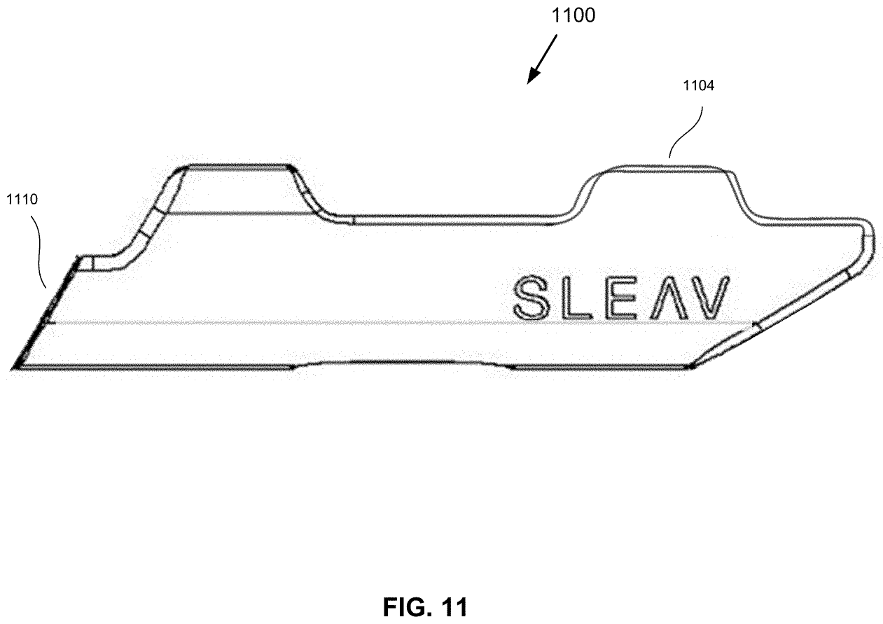

FIG. 11 is a side plan view of an alternative embodiment of a case 1100. The case 1100 is essentially the same as the case 200. However, the second strap 1104 is shifted toward the proximal end 1110 of the case 1100.

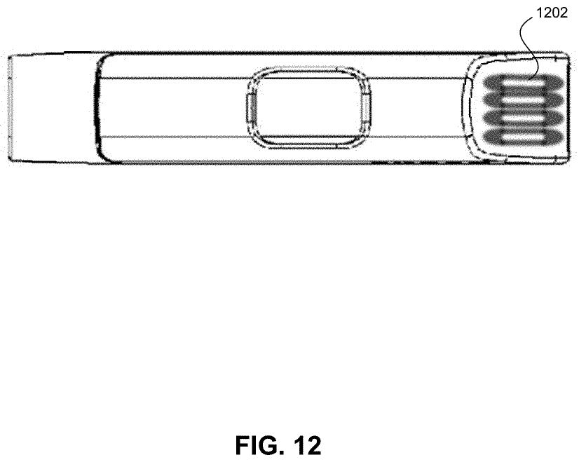

FIG. 12 is a bottom view of the case 1100. The case 1100 has a plurality of openings 1202 into the filter chamber 302, similar to the openings 902 of the case 200. However, rather than having six such openings 902, the case 1100 has only four openings 1202.

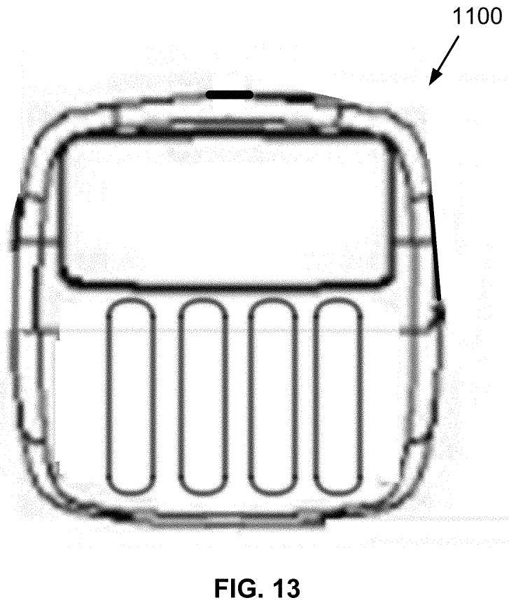

FIG. 13 is an end plan view of the case 1100.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A case for holding an e-cigarette and a filter cartridge comprising:
a) a body;
b) a filter chamber through the center of the body running coincident to first case longitudinal axis;
c) a first strap protruding from the body and defining a first receiving area partial ceiling at the bottom of the first strap;
d) a second strap protruding from the body and defining a second receiving area partial ceiling at the bottom of the second strap;
e) a receiving area left side wall formed within the body;
f) a receiving area right side wall formed within the body;
g) a receiving area floor formed within the body;
h) a receiving area running along a second case longitudinal axis, the receiving area defined by the first and second receiving area partial ceilings, the receiving area right and left side walls and the receiving area floor, the second case longitudinal axis being parallel to the first case longitudinal axis.
